(19) United States
(12) Patent Application Publication
(10) Pub. No.: US 2026/0115992 A1
(43) Pub. Date: Apr. 30, 2026

(54) Extruder Plasticization Assembly

(71) Applicant: Bausano & Figli S.P.A., Torino (IT)

(72) Inventor: Clemente Bausano, Torino (IT)

(73) Assignee: Bausano & Figli S.P.A., Torino (IT)

(21) Appl. No.: 18/902,172

(22) Filed: Sep. 30, 2024

(51) Int. Cl. B29C 48/92; B29C 48/80

(52) U.S. Cl. CPC B29C 48/92; B29C 48/832; B29C 48/834; B29C 2948/92704; B29C 2948/92895

(57) ABSTRACT

An extruder plasticization assembly has a plasticization cylinder, at least one thrust and plasticization screw rotatably mounted inside the plasticization cylinder, and a heat-adjustment unit to selectively control a temperature of the plasticization cylinder, the heat-adjustment unit comprises a heating device to heat by electromagnetic induction the plasticization cylinder and a cooling device to cool the plasticization cylinder.

### BACKGROUND OF THE INVENTION

The present invention relates to an extruder plasticization assembly. In particular, the present invention relates to an extruder plasticization assembly of the type comprising a plasticization cylinder, which has a feeding mouth communicating with a hopper to contain a plastic material, and further has an outlet provided with a die for an extruded product.

The plasticization assembly further comprises at least one thrust and plasticization screw mounted inside the plasticization cylinder in a rotary manner to impart to the plastic material a thrust from the feeding mouth to the outlet, and a heating device to heat the plasticization cylinder itself.

The heating device comprises at least one electrical resistor mounted around the plasticization cylinder.

The known extruder plasticization assemblies of the type described above have some drawbacks mainly due to the fact that the electrical resistor of the heating device has a relatively reduced efficiency and duration and that the heating device is unable to guarantee uniform heating of the plasticization cylinder.

### SUMMARY OF THE INVENTION

Object of the present invention is to provide an extruder plasticization assembly that is free of the drawbacks described above and that is simple and economical to implement.

An extruder plasticization assembly has a plasticization cylinder, at least one thrust and plasticization screw rotatably mounted inside the plasticization cylinder. A heat-adjustment unit is available to selectively control a temperature of the plasticization cylinder. The heat-adjustment unit comprises a heating device to heat by electromagnetic induction the plasticization cylinder and a cooling device to cool the plasticization cylinder.

According to the present invention, an extruder plasticization assembly is provided, as claimed in the appended claims.

### BRIEF DESCRIPTION OF THE DRAWINGS

FIG. 1 is a schematic perspective view, with parts removed for clarity's sake, of a preferred embodiment of a plasticization assembly of the present invention; and

FIG. 2 is a schematic perspective view, with parts removed for clarity's sake, of a detail of the plasticization assembly of FIG. 1.

### DETAILED DESCRIPTION OF THE INVENTION

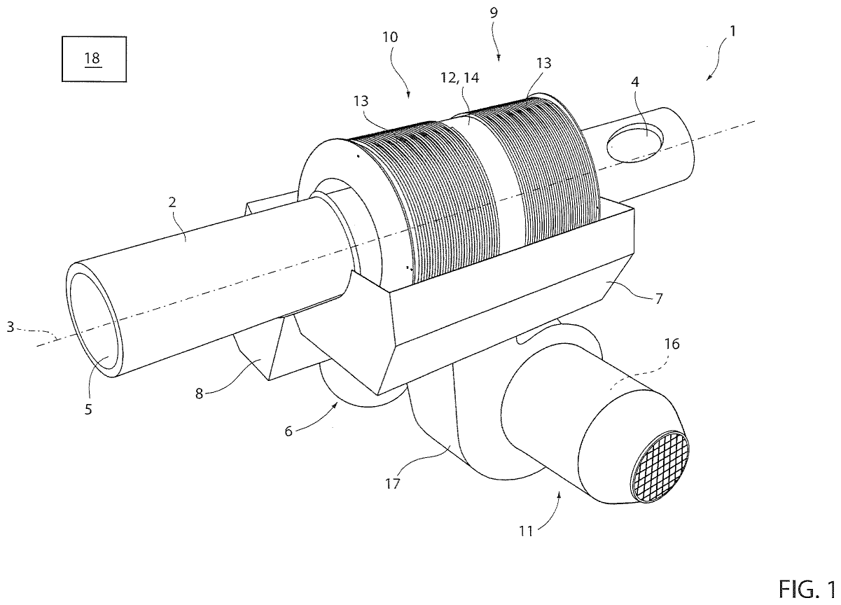

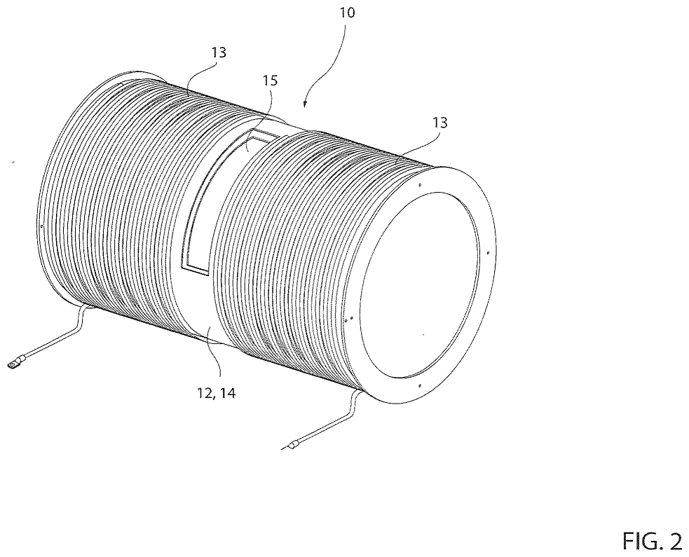

With reference to FIGS. 1 and 2, number 1 denotes an extruder plasticization assembly.

The plasticization assembly 1 comprises a plasticization cylinder 2 made of ferromagnetic material, which has a longitudinal axis 3, is provided with an inlet 4 connected with a hopper (not shown) to contain a plastic material and is also provided with an outlet 5 associated with a die (not shown) for an extruded product.

The cylinder 2 houses at least one thrust and plasticization screw (not shown), which is mounted to rotate around axis 3 and move and plasticize the plastic material from inlet 4 to outlet 5.

A central portion of cylinder 2 is housed inside a box-like containing body 6 comprising a lower tank 7 and an upper lid 8 which is movable between a closed position (not shown) and an open position (FIG. 1) of body 6.

The plasticization assembly 1 is also provided with a heat-adjustment unit 9 to selectively control a temperature of the cylinder 2.

The heat-adjustment Unit 9 comprises a heating device 10 to heat by electromagnetic induction the cylinder 2 and a cooling device 11 to cool the cylinder 2.

The heating device 10 comprises a sleeve 12 made of insulating material, which is housed inside the body 6, and extends around the cylinder 2 coaxially to the axis 3; and a pair of coils 13, which are helically wound on the sleeve 12, are mounted inside the body 6, and are electrically powered so as to generate an electromagnetic field suited to induce electromagnetic waves in the cylinder 2 and to heat the cylinder 2.

The coils 13 are spaced apart from one another to define therebetween a free portion 14 of the sleeve 12 provided with at least one opening 15 adapted to receive at least one detection device (not shown) fixed to the cylinder 2 to measure the temperature of the cylinder 2.

The cooling device 11 comprises an impeller (not shown) driven by an electric motor 16 and provided with a volute 17 connected with the body 6 to feed a flow of cooling air inside the body 6, through the opening 15, and along the cylinder 2.

Finally, the plasticization assembly 1 comprises an electronic control unit 18 connected with the heating device 10 and the cooling device 11 to selectively control operation of the devices 10, 11 and, therefore, the temperature of the cylinder 2.

With regard to the above, it should be specified that:
the number of the coils 13 may be other than two;
the coils 13 can be electrically powered by a single current generator or independently of each other through respective current generators so as to selectively control the temperature of the cylinder 2 along the axis 3; and
the insulating material of the sleeve 12 guarantees that the temperature is maintained within the ferromagnetic material of cylinder 2.

The plasticization assembly 1 has some advantages mainly due to the fact that the heating device 10 by electromagnetic induction has relatively low heating times of the cylinder 2 and energy consumption.

Furthermore, the heating device 10 allows the heat transmission to be started and stopped in relatively short times and has a relatively high precision in achieving and maintaining the temperature of the cylinder 2.

Finally, the heating device 10 has a relatively high efficiency and relatively low dissipation losses.

According to a variant not shown, the cooling device 11 is eliminated and replaced with a cooling device comprising a coil-shaped hydraulic circuit wound around and along the axis 3, and a pumping device to feed a cooling liquid along the coil-shaped hydraulic circuit.

In one embodiment, there is an extruder plasticization assembly (1) comprising a plasticization cylinder (2); at least one thrust and plasticization screw which is rotatably mounted inside the plasticization cylinder (2); and a heat-adjustment unit (9) to selectively control the temperature of the plasticization cylinder (2); wherein the heat-adjustment unit (9) comprises a heating device (10) to heat by electromagnetic induction the plasticization cylinder (2) and a cooling device (11) to cool the plasticization cylinder (2); wherein the heating device (10) comprises an insulating material sleeve (12) fitted on the plasticization cylinder (2) and two coils (13) wound on the sleeve (12) on opposite sides of a free portion (14) of the sleeve (12) and electrically powered so as to generate an electromagnetic field suited to induce an electric current in the plasticization cylinder (2); wherein a box-like containing body (6) is configured to house the heating device (10) and at least part of the plasticization cylinder (2); wherein the cooling device (11) comprises an impeller (16) to feed a cooling air flow through the containing body (6); and wherein the free portion (14) of the sleeve (12) has at least one opening (15) to allow the cooling air flow to enter inside the sleeve (12), between the plasticization cylinder (2) and the sleeve (12).

In another embodiment, there is plasticization assembly (1), wherein the cooling device (11) comprises a coil-shaped hydraulic circuit wound around, and along, a longitudinal axis (3) of the plasticization cylinder (2), and a pumping device to feed a cooling liquid along the coil-shaped hydraulic circuit.

In another embodiment, there is a plasticization assembly (1), further comprising an electronic control unit (18) to selectively control operation of the heating device (10) and of the cooling device (11).

The embodiments described may be combined in various ways. Variations of the described or shown embodiments is within the scope of the invention.

1. An extruder plasticization assembly comprising a plasticization cylinder; at least one thrust and plasticization screw which is rotatably mounted inside the plasticization cylinder and a heat-adjustment unit to selectively control the temperature of the plasticization cylinder; wherein the heat-adjustment unit comprises a heating device to heat by electromagnetic induction the plasticization cylinder and a cooling device to cool the plasticization cylinder; wherein the heating device comprises an insulating material sleeve fitted on the plasticization cylinder and two coils wound on the sleeve on opposite sides of a free portion of the sleeve and electrically powered so as to generate an electromagnetic field suited to induce an electric current in the plasticization cylinder; wherein a box-like containing body is configured to house the heating device and at least part of the plasticization cylinder; wherein the cooling device comprises an impeller to feed a cooling air flow through the containing body; and wherein the free portion of the sleeve has at least one opening to allow the cooling air flow to enter inside the sleeve, between the plasticization cylinder and the sleeve.

2. The plasticization assembly of claim 1, wherein the cooling device comprises a coil-shaped hydraulic circuit wound around, and along, a longitudinal axis of the plasticization cylinder, and a pumping device to feed a cooling liquid along the coil-shaped hydraulic circuit.

3. The plasticization assembly of claim 1, further comprising an electronic control unit to selectively control operation of the heating device and of the cooling device.
